(19) United States
(12) Patent Application Publication
(10) Pub. No.: US 2026/0054433 A1
(43) Pub. Date: Feb. 26, 2026

(54) VEHICLE SOUND INSULATION COMPONENT AND METHOD FOR ITS MANUFACTURE

(71) Applicant: Auria Solutions UK I, Ltd., London (GB)

(72) Inventors: Philipp Andreas Hilbert, Hannover (DE); Karl-Heinz Weber, Celle (DE)

(21) Appl. No.: 19/310,399

(22) Filed: Aug. 26, 2025

Related U.S. Application Data
(60) Provisional application No. 63/686,920, filed on Aug. 26, 2024.

(51) Int. Cl. B29C 44/12; B29K 75/00; B29K 631/00; B29L 31/30; B32B 5/20; B32B 27/06; B32B 27/30; B32B 27/40; B60R 13/08

(52) U.S. Cl. CPC B29C 44/1214; B32B 5/20; B32B 27/065; B32B 27/306; B32B 27/40; B60R 13/0815; B29K 2075/00; B29K 2631/04; B29K 2995/0002; B29K 2995/0063; B29K 2995/0097; B29L 2031/30; B32B 2250/02; B32B 2250/24; B32B 2266/0278; B32B 2307/102; B32B 2307/72; B32B 2307/7376; B32B 2605/00

(57) ABSTRACT

A vehicle sound insulation component comprising a sound barrier layer where foam is introduced to both sides of a sound barrier layer and where the foam can be configured to follow and accommodate various three-dimensional contours within the sound barrier layer. The foam can therefore replace the need to utilize sound absorbing fleece material.

### FIELD

The present disclosure relates to vehicle sound insulation component comprising a sound barrier layer where foam is introduced to both sides of a sound barrier layer and where the foam can be configured to follow and accommodate various three-dimensional contours within the sound barrier layer. The foam can therefore replace the need to utilize sound absorbing fleece material.

### BACKGROUND

Most vehicles have sound insulators designed to reduce noise emissions in the external environment as well as within the passenger compartment. These sound insulators are typically arranged in various locations on the motor vehicle's body-in-white. As used herein, “body-in-white” refers to any portion of the automobile's frame.

Such sound insulators are often located on a frame panel between the engine and the passenger compartment. Vehicle sound insulators often include a sound barrier layer and one or more sound absorbers applied to the sound barrier's surfaces. These sound absorbers further dampen noise and have historically been either fleece or foam. A sound barrier layer is therefore typically used for insulation and damping of metal sheets and metal parts in the vehicle.

There nevertheless exists an on-going need for improvements in the preparation of vehicle sound insulators that would include one or more foam absorbers where a precursor foam formulation is introduced through openings in the sound barrier layer where the foam absorbers as formed are positioned on both sides of the sound barrier layer in the same processing step and without having to simultaneously puncture the sound barrier layer. Such a process would then preferably remove the need to separately and manually position a two-dimensional fleece layer of uniform thickness.

### SUMMARY

A method producing a vehicle sound insulator component comprising:
a. providing a first mold portion and second mold portion;
b. providing a sound barrier layer having one or a plurality of openings for passage of a foam precursor, said one or plurality of openings define an opening area in the range of 1.0 cm² to 10.0 cm²;
c. placing the sound barrier layer between the first mold portion and second mold portion and closing the mold wherein the sound barrier layer is gripped between said first and second mold portions and defines a first lower cavity and second upper cavity each having a cavity thickness in the range of 0.1 mm to 50.0 mm;
d. injecting a foam precursor into said first lower cavity and through said one or plurality of openings into said second upper cavity; and
e. forming foam in said first lower cavity having a thickness in the range of 0.1 mm to 50.0 mm and forming foam in said second upper cavity having a thickness in the range of 0.1 mm to 50.0 mm, wherein said foam has a density in the range of 35 g/dm³ to 95 g/dm³.

### BRIEF DESCRIPTION OF THE DRAWINGS

Features and advantages of this disclosure will become more apparent as the following detailed description proceeds, and upon reference to the drawings, wherein like numerals designated like parts, and in which:

FIG. 1 illustrates in cross-section a preferred vehicle sound insulator component.

FIG. 2 illustrates in perspective view a preferred vehicle sound insulator component.

FIG. 3 illustrates in perspective view a preferred cross-sectional geometry for the one or plurality of openings 20.

FIG. 4 illustrates in perspective view a preferred cross-sectional geometry for the one or plurality of openings 20.

FIG. 5 illustrates in cross-section the preferred vehicle sound insulator component as applied to a vehicle's body-in-white (metallic) surface.

FIG. 6A illustrates in cross-section the sound barrier positioned between first and second mold portions.

FIG. 6B illustrates in cross-section the first and second mold portions in the closed position.

FIG. 6C illustrates in cross-section the first cavity and second cavity of the mold filled with foam absorber material.

FIG. 6D illustrates in cross-section the vehicle sound insulator produced from molding.

FIG. 7 illustrates a sound absorber layer where at locations “A” and “B” there is placement of fleece material.

FIG. 8 illustrates a sound absorber layer where at locations “C”, “D” and “E” the fleece has been replaced for the identified foam sections on top of the sound barrier layer 11.

FIG. 9 illustrates the comparative acoustic performance of a vehicle sound insulation component relying upon fleece versus the vehicle sound insulator component prepared herein providing foam on both sides of the sound barrier layer.

### DETAILED DESCRIPTION OF PREFERRED EMBODIMENTS

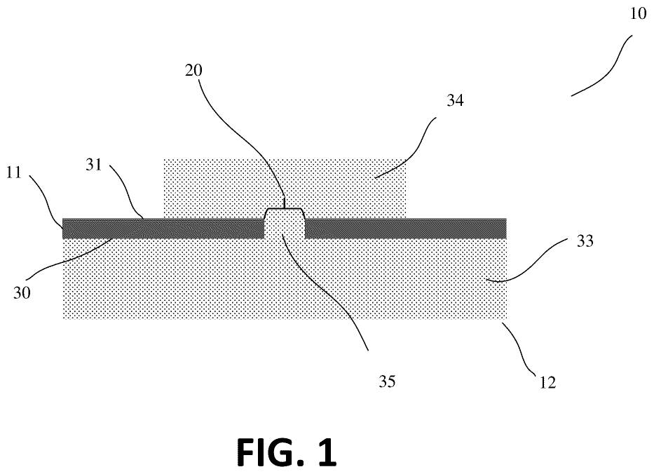

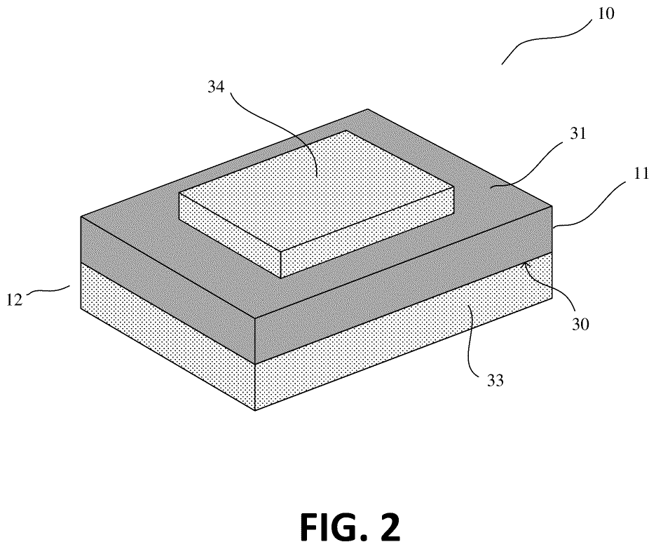

Preferred embodiments of the present invention will now be described. This will first include a description of the as-formed vehicle foam sound insulation component and then the corresponding preferred process for its formation. FIGS. 1 & 2 therefore provide a preferred construction of the as-formed vehicle sound insulation component 10 herein. More specifically, FIG. 1 depicts a cross-sectional view and FIG. 2 depicts a perspective view of a sub-section of the preferred vehicle foam sound insulation component 10.

As can be seen in FIGS. 1 & 2, the preferred vehicle sound insulator component 10 herein includes a sound barrier layer 11 and one or a plurality of foam absorbers 12. The sound barrier layer preferably comprises a polymeric resin, preferably PE-EVA (polyethylene ethylene vinyl acetate) or a thermoplastic elastomer (TPE). In particular, thermoplastic polyolefin elastomers TPO or TPV may preferably be used, which comprises polypropylenes having up to 65% ethylene-propylene [diene] rubber (EP[D]M) incorporated therein. The sound barrier layer may also comprise thermoplastic elastomers that rely upon a polystyrene component in combination with polyethylene and polybutadiene, the so-called SEBS resins. The sound barrier layer also preferably contains additives and fillers. The sound barrier layer herein preferably has a thickness in the range of 0.1 mm to 6.0 mm, including all individual values and increments therein, and a density of 0.6 kg/m² to 8.0 kg/m², including all individual values and increments therein. The foam can therefore replace the need to utilize sound absorbing fleece material.

The one or plurality of openings 20 are such that they are of variable geometry and the one or plurality of openings 20 preferably provide an opening area in the range of 1.0 cm² to 10.0 cm² including all values and increments therein. More preferably, the one or plurality of openings 20 in the sound barrier layer 11 define an area in the range of 0.5 cm² to 2.5 cm². The one or plurality of openings 20 may therefore be round, oval, rectangular, square, triangular, polygonal, or a mixture of such geometries.

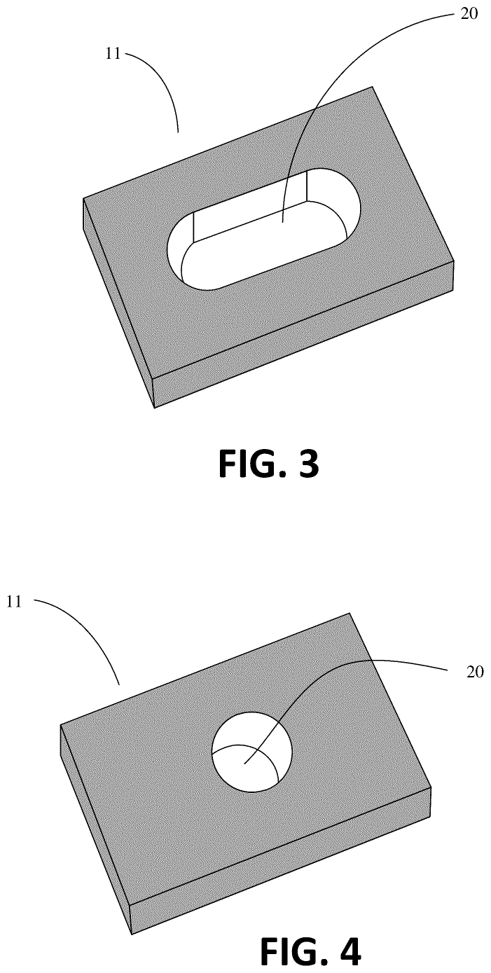

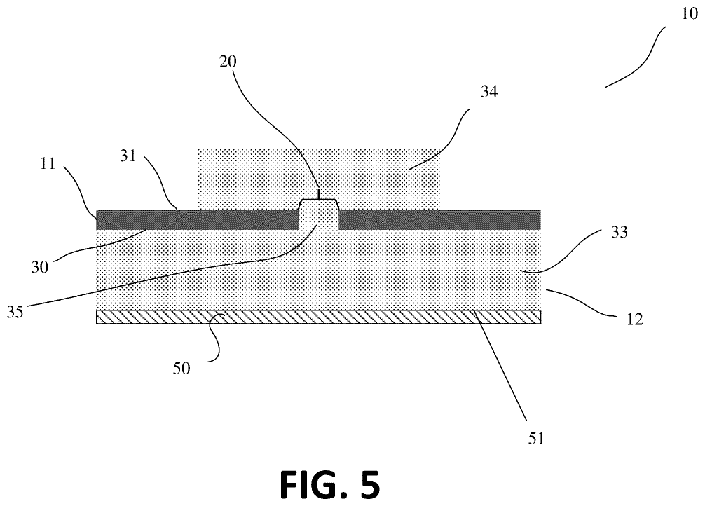

A preferred embodiment of the one or more openings 20 is shown in FIG. 3, where the cross-sectional geometry may be described as slot shaped. Another embodiment of the one or more openings 20 is next shown in FIG. 4, where the cross-sectional geometry is now round. The total number of openings 20 in the sound barrier layer, for the passage of foam precursor during production, may preferably fall in the range of 1-10 openings, including all values and increments therein. More preferably, there may be 1-5 openings present in the sound barrier layer 11. In addition, reference to foam precursor herein is reference to the ingredients that one typically employs to produce a given foam formulation, which therefore includes reactants to form a selected polymeric resin and an appropriate foaming agent.

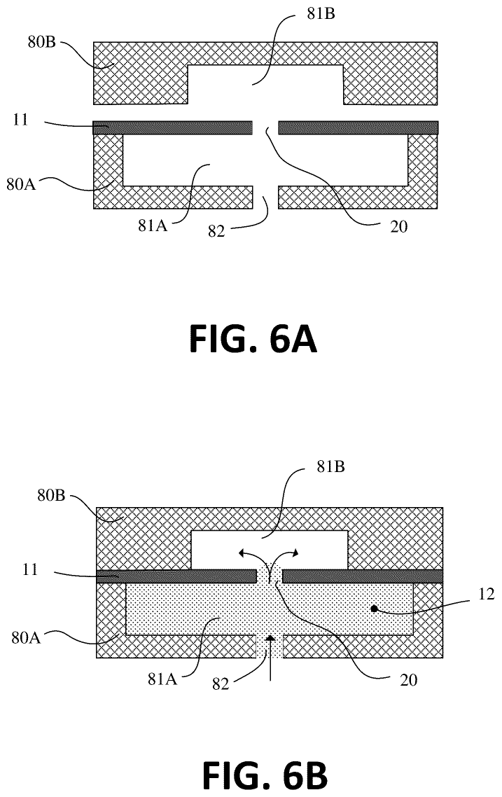

With attention now directed to FIG. 5, the sound barrier layer 11 has a front surface 30, a back surface 31, and as noted, one or more openings 20 extending between the first surface 30 and the back surface 31. The one or plurality of foam absorber(s) 12 have a front portion 33 molded onto the front surface 30 of the sound barrier layer 11, a back portion 34 also molded onto the back surface 31 of the sound barrier layer 11, and a middle portion 35 connecting the back portion 34 and the front portion 33 through the one or more openings 20. As shown in FIG. 5, the vehicle insulator component 10 may be installed on a vehicle's body-in-white 50. Preferably, the vehicle insulator component 10 may be installed on a portion of a vehicle's body-in-white 50 such that the front surface 33 of the foam absorber(s) 12 contacts a surface of the vehicle's body-in-white 50.

The one or plurality of foam absorber(s) 12 preferably comprises polyurethane foam. The density of the foam absorber(s) 12 is preferably in the range of 35 g/dm³ to 95 g/dm³, including all values and increments therein, where g/dm³ is reference to the units of grams per decimeter cubed. More preferably the density of the one or plurality of foam absorber(s) 12 may be in the range of 50 g/dm³ to 80 g/dm³. The front portion 33 of the foam absorber(s) 12 may have a thickness extending perpendicularly away from the area on the front surface 30 of the sound barrier layer 11 extending to the surface 51 of the body-in-white 50. This thickness of the front portion 33 may preferably be in the range of 0.1 mm to 50.0 mm, including all values and increments therein, such as more preferably in the range of 5.0 mm to 25.0 mm. The back portion 34 of the foam absorber(s) 12 may have a thickness extending perpendicularly away from the area on the back surface 31 of the sound barrier layer 11 that is in contact with the back portion 34. The thickness of the back portion 34 may preferably be in the range of 0.1 mm to 50.0 mm, more preferably in the range of 5 mm to 15 mm.

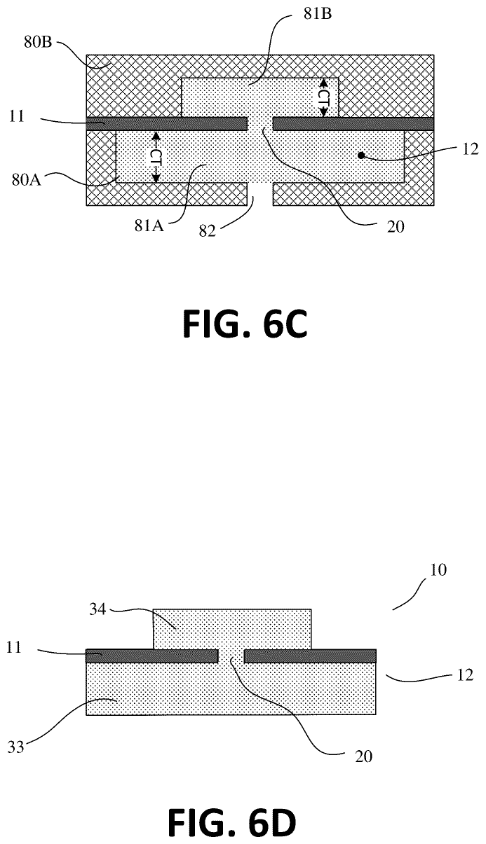

Additionally, the present disclosure relates to a method of producing an automotive insulator comprising a sound barrier layer and one or more foam absorbers as depicted in FIGS. 6A, 6B, 6C and 6D. As observed in FIG. 6A one provides a sound barrier layer 11 having one or a plurality of openings 20 and places the sound barrier 11 between a first 80A and second 80B mold portions of an injection molding tool. The first injection mold portion 80A preferably has a first mold cavity 81A and the second injection mold portion 80B preferably has a second mold cavity 81B. The sound barrier layer 11 is then placed between the two injection molding portions 80A, 80B so that the one or plurality of openings 20 in the sound barrier layer 11 is/are positioned between the first mold cavity 81A and the second mold cavity 81B.

One of the first or second injection mold portions 80A or 80B preferably has an inlet 82 where precursor foam absorber material may be injected. FIG. 6B depicts the first and second mold portions in the closed position and the sound barrier layer 11 is now gripped between the first and second mold portions. The first injection molding portion 80A has an inlet 82 where the foam absorber precursor material is injected into the first cavity 81A and flows through the one or plurality of openings 20 in the sound barrier layer 11 and into the second cavity 81B. As therefore may be appreciated, the sound barrier layer now gripped in the mold defines first lower cavity 81A and second upper cavity 81B. The first lower cavity and second upper cavity each preferably defines a cavity thickness (CT) in the range of 0.1 mm to 50 mm, including all values and increments therein. It should be noted that the cavity thickness of the second upper cavity 81B is more preferably in the range of 5.0 mm to 15.0 mm. The cavity thickness of the first lower cavity 81A is preferably in the range of 5.0 mm to 25.0 mm.

FIG. 6C depicts the first cavity 80A, the opening(s) 20 in the sound barrier layer 11, and the second cavity 80B after they have been filled and have formed foam absorber material 12. FIG. 6D depicts a cross-section of the vehicle sound insulator 10 created in the preceding steps after the first and second injection mold portions 80A, 80B have been removed. As can be seen, sound barrier layer 11 has one or a plurality of foam absorber(s) 12 molded onto both sides of and through the opening(s) 20 in the sound barrier layer 11.

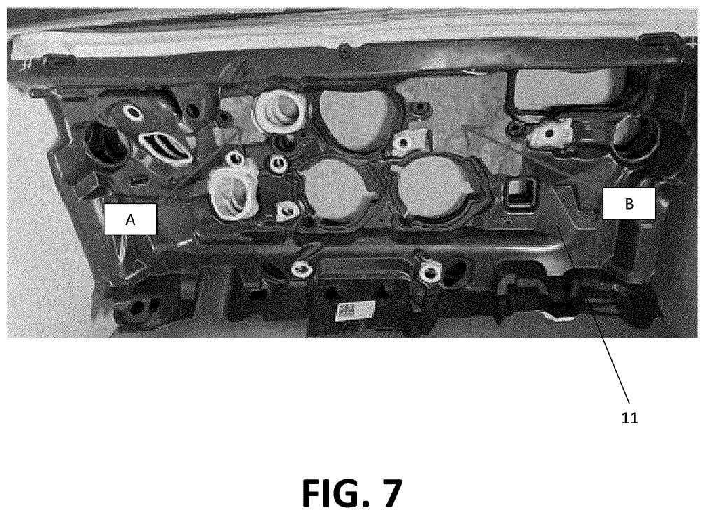

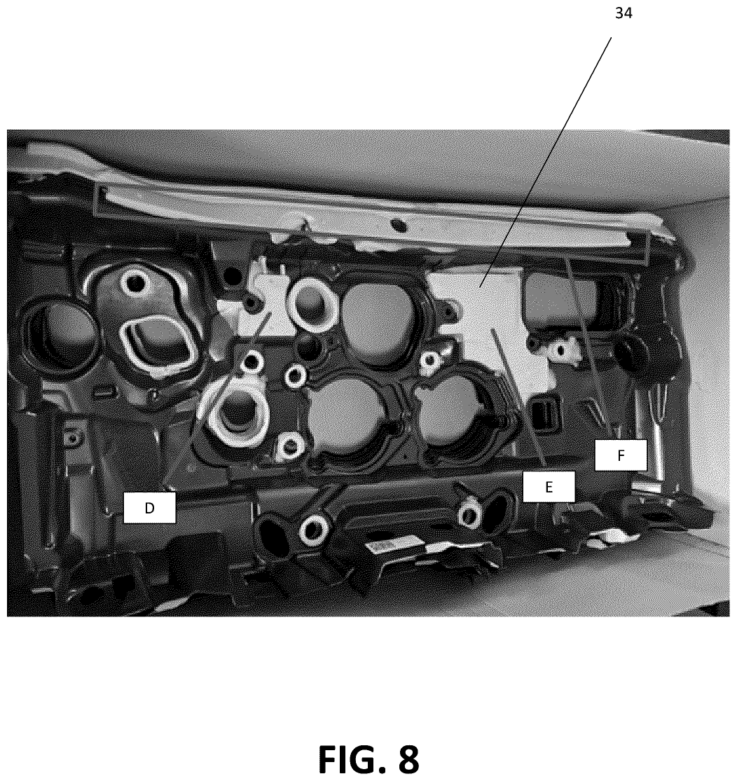

FIG. 7 illustrates a sound barrier layer 11 where at locations “A” and “B”, one previously relied upon the placement of fleece material on the sound barrier layer 11. As next illustrated in FIG. 8, by the placement of a plurality of openings 20 in the sound barrier layer 11, and following the molding procedure discussed herein, one can introduce the foam precursor between the sound barrier layer and body in white, and at locations “D”, “E” and “F” one can replace the fleece and selectively form foam sections 34 on the back surface 31 of the sound barrier layer.

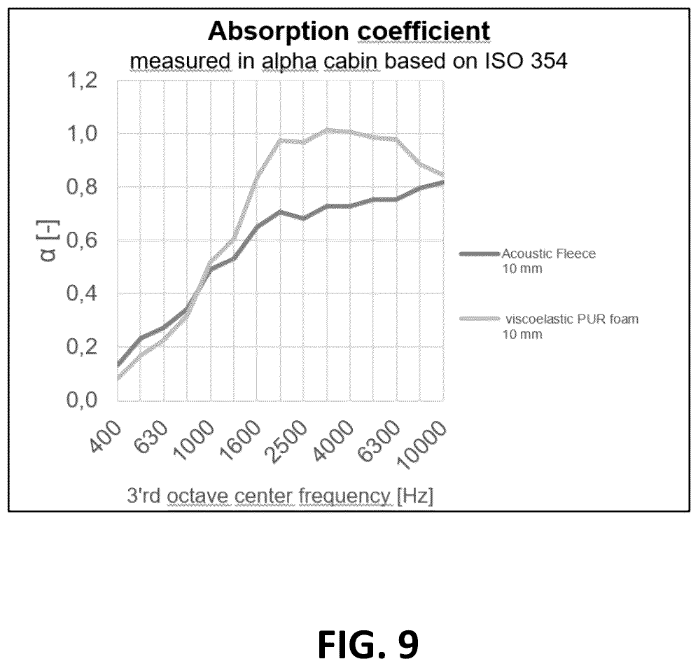

FIG. 9 next illustrates by comparison the acoustic performance of a vehicle sound insulator component relying upon fleece versus the vehicle sound insulator component herein providing foam on both sides of the sound barrier layer. Testing was conducted according to current ISO354 protocols (Measurement of Sound Absorption In A Reverberation Room). A plot is provided showing the sound absorption coefficient (a) versus frequency. As can be observed, the use of the foam absorber herein selectively introduced through selected openings 20 in the sound barrier layer and positioned on both sides of the sound barrier layer 11 offers much improved performance.

1. A method producing a vehicle sound insulator component comprising:
a. providing a first mold portion and second mold portion;
b. providing a sound barrier layer having one or a plurality of openings for passage of a foam precursor, said one or plurality of openings define an opening area in the range of 1.0 cm² to 10.0 cm²;
c. placing the sound barrier layer between the first mold portion and second mold portion and closing the mold wherein the sound barrier layer is gripped between said first and second mold portions and defines a first lower cavity and second upper cavity each having a cavity thickness in the range of 0.1 mm to 50.0 mm;
d. injecting a foam precursor into said first lower cavity and through said one or plurality of openings into said second upper cavity; and
e. forming foam in said first lower cavity having a thickness in the range of 0.1 mm to 50.0 mm and forming foam in said second upper cavity having a thickness in the range of 0.1 mm to 50.0 mm, wherein said foam has a density in the range of 35 g/dm³ to 95 g/dm³.

2. The method of claim 1 wherein said one or plurality of openings in said sound barrier comprises 1-10 openings.

3. The method of claim 1 wherein said one or plurality of openings in said sound barrier comprises 1-5 openings.

4. The method of claim 1 wherein said sound barrier has a thickness in the range of 0.1 mm to 6.0 mm and a density in the range of 0.6 kg/m² to 8.0 kg/m².

5. The method of claim 1 wherein said sound barrier comprises a polymeric resin.

6. The method of claim 5 wherein said polymeric resin comprises polyethylene ethylene vinyl acetate or thermoplastic elastomer.

7. The method of claim 5 wherein said polymeric resin comprises thermoplastic polyolefin elastomers.

8. The method of claim 7 wherein said thermoplastic polyolefin elastomer comprises polypropylene having up to 65% ethylene-propylene-diene rubber incorporated therein.

9. The method of claim 1 wherein said first lower cavity has a thickness in the range of 5.0 mm to 25.0 mm and forming foam in said first lower cavity at a thickness in the range of 5.0 mm to 25.0 mm.

10. The method of claim 1 wherein said second upper cavity has a thickness in the range of 5.0 mm to 15.0 mm and forming foam in said second upper cavity at a thickness in the range of 5.0 mm to 15.0 mm.

11. The method of claim 1 wherein said foam comprises polyurethane foam.

12. The method of claim 1 wherein said upper second cavity has a thickness of 5.0 mm to 15.0 mm.

13. A method producing a vehicle sound insulator component comprising:
a. providing a first mold portion and second mold portion;
b. providing a sound barrier layer having one or a plurality of openings for passage of a foam precursor, said one or plurality of openings define an opening area in the range of 1.0 cm² to 10.0 cm²;
c. placing the sound barrier layer between the first mold portion and second mold portion and closing the mold wherein the sound barrier layer is gripped between said first and second mold portions and defines a first lower cavity having a thickness in the range of 0.1 mm to 50.0 mm and second upper cavity having a cavity thickness in the range of 5.0 mm to 15.0 mm;
d. injecting a foam precursor into said first lower cavity and through said one or of openings into said second upper cavity; and
e. forming polyurethane foam in said first lower cavity having a thickness in the range of 0.1 mm to 50.0 mm and forming polyurethane foam in said second upper cavity having a thickness in the range of 0.1 mm to 15.0 mm, wherein said foam has a density in the range of 35 g/dm³ to 95 g/dm³.

14. The method of claim 13 wherein said first lower cavity has a thickness in the range of 5.0 mm to 25.0 mm.
